(19) United States
(12) Patent Application Publication
(10) Pub. No.: US 2018/0338429 A1
(43) Pub. Date: Nov. 29, 2018

(54) METHOD AND DEVICE FOR STORING AGRICULTURAL PRODUCTS

(71) Applicant: Agriculture Victoria Services PTY LTD, Attwood (AU)

(72) Inventor: Sock Chin Gouk, Lysterfield (AU)

(21) Appl. No.: 15/771,396

(22) PCT Filed: Mar. 22, 2016
(86) PCT No.: PCT/AU2016/050204

§ 371 Date: Apr. 26, 2018

(30) Foreign Application Priority Data
Oct. 27, 2015 (AU) 2015904396

(51) Int. Cl. A01F 25/13; B32B 27/06

(52) U.S. Cl. CPC A01F 25/13; B32B 27/06; B32B 2410/00; B32B 2250/03; B32B 2307/7265; B32B 2307/724

(57) ABSTRACT

The present invention provides a cover for an agricultural product, said cover including a polymeric barrier material, wherein the cover is permeable or impermeable to gases, permeable to water vapour and water-resistant.

### FIELD OF THE INVENTION

The present invention relates to device for storing agricultural products, more particularly a cover for an agricultural product, particularly a food product, and associated methods.

### BACKGROUND OF THE INVENTION

Agricultural produce and products contain varying levels of moisture. In some fresh and perishable products, high moisture content is an important criterion governing crispness and juiciness. Alternatively, low moisture content may be required, including in products undergoing prolonged storage. Temperature, light, relative humidity, moisture migration and direct exposure to external moisture are examples of factors impacting on moisture content, and may contribute to a product acquiring additional moisture. Products containing unacceptable levels of moisture may spoil rapidly, due to oxidative, biochemical and biological reactions and processes.

Certain biochemical changes which may render products unacceptable for their intended use occur particularly in food products that contain carbohydrates, proteins and/or fatty acids, especially during storage. These compounds can undergo oxidation (i.e. autoxidation and/or photo-oxidation), leading to production of chemicals that taint foods. This oxidative breakdown is generally known as rancidity, and is an important indicator of food quality. Rancidity may be accelerated when the moisture content exceeds the critical threshold of a product. High moisture content may activate naturally-occurring hydrolytic enzymes which break down fats and/or oils to release free fatty acids. Oxidative breakdown produces volatile aldehyde and ketone secondary metabolites, which cause off-flavours and off-odours.

Microbial growth may also be responsible for loss of product integrity or spoilage. Spoilage may also affect the quality attributes of processed products made from affected produce. Microbes often require certain moisture levels in order to proliferate. Water activity (a_{w}) is a measure of the energy of water in a product, and is the dominant indicator for predicting shelf life expectancy and/or the potential for spoilage by microbial growth. Specific a_{w} limits have been defined for a combination of many products and microorganisms, predicting the level beyond which spoilage is likely to occur.

Growth of certain microorganisms and associated metabolic activities generate odour compounds, resulting in food taints. Unpleasant odours may be absorbed by surrounding foodstuff or packaging materials. Microbial species responsible for off-flavours include bacteria, fungi and yeasts, especially in plant products. For example, the fungi Penicillium spp. produce geosmin, which is associated with ‘earthy’ off-flavour. Some fungi are also known to produce phenolic compounds causing off-flavours in produce. Many microbes can generally grow in foods at a_{w} of 0.62 to 1, pH of from 1.5 to 10, and temperatures of from −3 to 75° C.

Foodborne pathogens are also a significant concern in foods consumed by humans and livestock. Contamination by pathogens such as Escherichia coli, Salmonella and Listeria spp., may cause individual incidences or widespread cases of discomfort, sickness or even death when ingested. These and other foodborne pathogens may cause problems through proliferation in food whilst in storage.

Mycotoxic fungi are also a significant concern. Common mycotoxic fungi are widespread in nature and are well adapted to colonising substrates. The majority of the mycotoxic fungi can grow in substrates with a_{w} of less than 0.85. They produce a range of potent mycotoxins. For example, Aspergillus, Fusarium and Penicillium spp. produce some of the most potent mycotoxins, including aflatoxins, trichothecenes, fumonisins, zearalenone and patulins. A list of major mycotoxins found in food and foodstuffs is shown in Table 1.

TABLE 1
Mycotoxins found in foods and foodstuffs

| Commodity | Situation | Potential mycotoxins |
|---|---|---|
| Cereals | Pre-harvest fungal | Deoxynivalenol, T2 toxin, |
| | infection | nivalenol, zearalenone, |
| | | alternariol, alternariaol |
| | | monomethyl ether, |
| | | tenuazonic acid, fumonisins |
| Maize and | Pre-harvest fungal | aflatoxins |
| peanuts | infection | |
| Maize and | Pre-harvest fungal | fumonisins |
| sorgham | infection | |
| Stored | Damp storage | Aflatoxins and ochratoxin |
| cereals, nuts, | conditions | |
| spices | | |
| Fruit juice | Mould growth on | Patulin |
| | fruit | |
| Dairy | Animal consumption | Aflatoxin M, cyclopiazonic |
| products | of mould | acid, ochratoxin, |
| | contaminated feeds | compactin, cyclopaldic acid |
| Meat and | Animal consumption | Patulin, citrinin, ochratoxin, |
| eggs | of mould | cyclopiazonic acid, cyclopaldic |
| | contaminated feeds | acid, citromycetin, roquefortine, |
| | | fumonisins |
| Oilseeds | Pre-harvest fungal | Tenuazonic acid, alternariol |
| | infection | |

These secondary metabolites are toxic to human and animals when ingested, at times with fatal effects. Aflatoxins are the most acutely toxic. They may be carcinogenic, immunosuppressive, hepatoxic, and tetratogenic when ingested. Mycotoxins are heat stable and not easily removed from foods or feedstuff by processing.

Fungi may also be allergenic. For example, a large number of fungal genera from three phyla, Ascomycota, Basidiomycota and the Deuteromycota are allergenic. They include common plant pathogens and saprophytes such as, for example, Alternaria, Aspergillus, Cladosporium, Epiccocum, Fusarium, Rhizopus spp., and the rust and smut fungi. This is particularly concerning when harvest and postharvest conditions enable proliferation of allergenic microorganisms. Dust and microbial propagules are generated and distributed by agricultural production processes and downstream processing, which poses a health risk to humans and animals. For example, airborne toxicoses can be caused by pulmonary infection in susceptible subjects.

Another problem is spontaneous combustion of certain stored products, which occurs when a product self-heats and the auto-ignition temperature is reached. Self-heating of biological materials, including agricultural products such as biofuel feedstock, involves a combination of physical, biochemical and biological decomposition processes. Tendency to self-heat is found mostly in agricultural products which contain high fat and oil content, and also those susceptible to hydrolytic and enzymatic cleavage of fat which produces glycerol and fatty acids with a low flash point temperature (i.e. as described above). Continued decomposition, together with release of volatile gases can eventually lead to a pyrophoric gas phase that combust readily. Only a small amount of moisture can trigger self-heating within a few hours.

Moisture content thus has a central role in physiological activity in a product, and moisture content control is therefore important in maintaining the integrity of agricultural produce and products.

Much emphasis on controlling product quality and shelf life tends to be directed at optimising packaging of products, while storage conditions are not a focus. This is especially the case in agricultural operations, where products, including perishables, are typically stored in the field for varying periods until processed or utilised. Common processing practices do not adequately remove spoiled or contaminated produce. These products are often stored in stockpiles, bunkers, sheds and various vessels (i.e. for transport, shipping and processing), lined or with a cover or bag to protect the product from the weather (i.e. dew, rain, snow, hail, mist, fog, light, etc.). Typical covers, linings and bags are constructed of polymeric materials such that, while often water-proof, they trap moisture and cause condensation build up, leading to many of the associated problems discussed above.

It is an object of the present invention to overcome, or at least alleviate, one or more of the difficulties or deficiencies associated with the prior art.

### SUMMARY OF THE INVENTION

In a first aspect, the present invention provides a cover for an agricultural product, including a polymeric barrier material, wherein the cover is permeable to gases, in particular air, permeable to water vapour and water-resistant.

In an alternate aspect, the present invention provides a cover for an agricultural product, including a polymeric barrier material, wherein the cover is substantially impermeable to gases, in particular air, permeable to water vapour and water-resistant.

By the term ‘cover’, as used herein, is meant a physical barrier.

The term ‘gases’ includes gas mixtures, such as air. By the term ‘air’, as used herein, is meant the gas surrounding the earth, a mixture mainly of oxygen and nitrogen. The term ‘gases’ also includes gases produced by microorganisms, such as methane and carbon dioxide, or manually applied gas compounds, such as fumigants.

By the term ‘permeable to gases’, as used herein, is meant that the cover allows passage of one or more gases, in particular air, there through or is capable of being passed through or permeated by one or more gases, in particular air. The term includes within its scope limited passage of one or more gases such as air there through, i.e. the gas need not be able to pass freely through the cover and the cover may limit passage of the gas there through.

By the term ‘impermeable to gases’, as used herein, is meant that the cover does not allow the passage of one or more gases, in particular air, there through, or allows the passage of minimal amounts of one or more gases there through, or is substantially incapable of being passed through or permeated by one or more gases, in particular air.

By the term ‘permeable to water vapour’, as used herein, is meant that the cover allows passage of water vapour there through or is capable of being passed through or permeated by water vapour. The term includes within its scope limited passage of water vapour there through, i.e. the water vapour need not be able to pass freely through the cover and the cover may limit passage of water vapour there through.

By the term ‘water-resistant’, as used herein, is meant that the cover resists the passage of liquid water there through.

The cover may be any article fit for purpose, and it need not make a complete containment or surrounding. For example, the cover may be a wrap, lining, bag, tarpaulin, sheet, container or other receptacle. Preferably, the cover is a lining, sheet or tarpaulin, and most preferably a tarpaulin.

Similarly, the cover may be of any size or shape fit for purpose. There is no upper limit to the size of the cover, as it may be made by joining pieces of polymeric material or laminate together. For example, the cover may be of a size such that it spans a surface area of from approximately 1 m² to approximately 200,000 m².

In a preferred embodiment, the cover may span a surface area of from approximately 5 m² to approximately 80,000 m², more preferably from approximately 100 m² to approximately 65,000 m².

In a preferred embodiment pieces of the cover may be joined to span a large surface area. Preferably, pieces of polymeric material or laminate may be joined to create a wide span cover. The pieces may be joined in a manner such that the seams are water resistant. Depending on application, the seam may also be a semi or non-water resistant seam. The pieces may be joined by stitching, adhesive, tape, welding or any other suitable method and may be heat or pressure sealed so that they are water resistant.

In a preferred embodiment, the cover may include fastening means, such as tapes, tabs, handles or loops, attached along its perimeter, to aid handling and fastening of the cover.

The permeability of the cover may be such that it presents little or no resistance to the passage of air and water vapour there through, or such that a certain pressure differential exists across the cover in order to encourage passage. Preferably, the cover is characterised by a water-vapour resistance (breathability) of between 0 and approximately 15 m²Pa/W, more preferably between 0 and approximately 13 m²Pa/W, more preferably between 0 and approximately 10 m²Pa/W, when measured according to ISO 11092.

Permeability may be provided, for example, by way of holes, channels or pores in the cover. Preferably, the cover is microporous, with a pore size that permits water vapour to pass through but is small enough to resist the passage of liquid water.

The permeability rate of the cover may be varied by the use of different polymeric materials and additional materials, as hereinafter described. In certain applications, the pore size may be selected to allow various rates of evaporation.

In certain situations the permeability of the cover may be such that it is substantially impermeable to gases, but presents little or no resistance to the passage of water vapour there through. For example, a cover that is substantially impermeable to gases may be used to minimise release of fumigants, in particular fumigants that have been applied to the agricultural product prior to it being covered.

The water resistance property of the cover may be such that it prevents the passage of most to substantially all liquid water there through unless a certain pressure differential exists across the cover to force passage. Alternatively, or in addition, certain chemicals, e.g. surfactants, may be used to lower water resistance of the cover.

Preferably, the cover offers a hydrostatic resistance of between approximately 60 and approximately 300 kPa, more preferably between approximately 100 and approximately 275 kPa. Particularly preferred embodiments have a hydrostatic resistance of between approximately 100 kPa and approximately 150 kPa, according to AS 2001.2.17.

Examples of waterproof ratings (mm) are given in Table 2. To enable comparison, particularly preferred hydrostatic resistance of 100 kPa is around 5,000 mm, and particularly preferred hydrostatic resistance of 147 kPa is around 15,000 mm.

TABLE 2
Waterproof ratings

| Waterproof Rating | | | What it can |
|---|---|---|---|
| (mm) | | Resistance provided | withstand |
| 0-5,000 | mm | No resistance to some | Light rain, dry |
| | | resistance to moisture | snow, no pressure |
| 6,000-10,000 | mm | Rainproof and waterproof | Light rain, |
| | | under light pressure | average snow, |
| | | | light pressure |
| 11,000-15,000 | mm | Rainproof and waterproof | Moderate rain, |
| | | except under high pressure | average snow, |
| | | | light pressure |
| 16,000-20,000 | mm | Rainproof and waterproof | Heavy rain, wet |
| | | under high pressure | snow, some pressure |
| 20,000 | mm+ | Rainproof and waterproof | Heavy rain, wet |
| | | under very high pressure | snow, high pressure |

Preferably, the cover offers a water repellency scale of approximately 50 to approximately 270, more preferably approximately 75 to approximately 150, more preferably approximately 100, according to AS 2001.2.16.

Table 3 shows water vapour permeability and water vapour/N₂ selectivity for various polymers.

TABLE 3
Water vapour permeability and water vapour/N₂ selectivity for various
polymers at 30° C. extrapolated to water vapour activity 0

| | H₂O permeability | Selectivity |
|---|---|---|
| Polymer | (Barrer) | (H₂O/N₂) |
| Polyethylene | 12 | 5.71 |
| Polyvinylalcohol | 19 | 33,300 |
| Polypropylene | 68 | 230 |
| Polyamide 6 (Nylon 6) | 275 | 11.000 |
| Polyvinylchloride | 275 | 12,500 |
| Polyacrylonitril | 300 | 1,875,000 |
| Polyimide (Kapton) | 640 | 5,333,300 |
| Polystyrene | 970 | 400 |
| Polycarbonate | 1,400 | 4,700 |
| Polysulfone | 2,000 | 8,000 |
| Natural rubber | 2,600 | 300 |
| Polyethersulfone | 2,620 | 10,480 |
| Polyphenyleneoxide | 4,060 | 1,070 |
| Cellulose acetate | 6,000 | 24,000 |
| Sulfonated polyethersulofon | 15,000 | 214,300 |
| Ethyl cellulose | 20,000 | 6,060 |
| Polydimethylsiloxane | 40,000 | 140 |
| Sulfonated | 61,000 | 10,166,700 |
| polyethereterdeton | | |
| 1000PED40PBT60 | 104,000 | 40,000 |

Use of the cover of the present invention may result in reduced microbial levels, for example levels of fungi, such as Aspergillus spp. and Penicillium spp., and bacteria in an agricultural product, such as nuts, stored under the cover, when compared with use of a conventional polymeric cover.

By a conventional polymeric cover is meant a polymeric cover that is substantially non-permeable to water vapour, for example one made of polyethylene.

Fungal levels may be significantly lower in the agricultural product stored under the cover of the invention, when compared with agricultural product stored under a conventional cover. The levels may vary depending on the season, the initial level of contamination and/or the initial moisture content of the agricultural product. For example, fungal levels may be at least approximately 2 times lower, more preferably at least approximately 10 times lower, more preferably at least approximately 20 times lower, more preferably at least approximately 30 times lower in agricultural products such as nuts after storage under the cover. The agricultural product may be stored for a period of approximately 1 week to approximately 1 year, more preferably approximately 2 weeks to approximately 9 months, more preferably approximately 4 weeks to approximately 3 months.

Fungal levels may be between 0 and approximately 2000 cfu/g, more preferably between 0 and approximately 1000 cfu/g, more preferably between 0 and approximately 500 cfu/g in agricultural products such as nuts after storage under the cover for a period of approximately 1 week to approximately 1 year, more preferably approximately 2 weeks to approximately 9 months, more preferably approximately 4 weeks to approximately 3 months.

The reduced fungal levels may in turn result in reduced levels of mycotoxins in an agricultural product, such as nuts, stored under the cover, when compared with use of a conventional polymeric cover, for example one made of polyethylene.

Bacterial levels may be significantly lower in the agricultural product stored under the cover of the invention, when compared with agricultural product stored under a conventional cover. The levels may vary depending on the season, the initial level of contamination and/or the initial moisture content of the agricultural product. For example, bacterial levels may be at least approximately 2 times lower, more preferably at least approximately 10 times lower, more preferably at least approximately 50 times lower, more preferably at least approximately 100 times lower in agricultural products such as nuts after storage under the cover for a period of approximately 1 week to approximately 1 year, more preferably approximately 2 weeks to approximately 9 months, more preferably approximately 4 weeks to approximately 3 months, when compared with use of a conventional polymeric cover, for example one made of polyethylene.

Bacterial levels may be between 0 and approximately 50,000 cfu/g, more preferably between 0 and approximately 20,000 cfu/g, more preferably between 0 and approximately 10,000 cfu/g in agricultural products such as nuts after storage under the cover for a period of approximately 1 week to approximately 1 year, more preferably approximately 2 weeks to approximately 9 months, more preferably approximately 4 weeks to approximately 10 weeks.

As stated above, the cover includes a polymeric material. The cover may be formed from any suitable polymeric material which is permeable to gases and water vapour. For example, the polymeric material may include one or more of a fluoropolymer, polyolefin, polyester, polyurethane, polyethylene, polyvinyl chloride and polyvinylidene chloride. Preferably, the polymeric material includes a fluoropolymer, and most preferably polytetrafluoroethylene.

The cover may consist solely of the polymeric material, or it may include additional materials. For example, the cover may include two or more materials, which may be bonded, knitted or interwoven together. In a preferred embodiment, the cover includes a laminate. Preferably, the laminate consists of three layers, including the polymeric material between an outer and an inner layer. The outer and/or inner layer may also include a polymeric material, or each may be made up of different materials.

The cover may be coated, for example the outer and/or inner layers may be coated, for additional water repellency, strength or protection properties for the cover. For example, the cover may have a coating to provide protective properties against microbial and/or pest infection.

The outer and/or inner layer may contribute a desired property to the cover. The outer and/or inner layer may provide or improve water repellency, heat emission/absorption, light penetration/reflection, strength or other protective properties to the cover. In a preferred embodiment, the outer and inner layers include either or both of a woven and knit fabric. More preferably, one layer is a woven fabric and the other is a knit fabric. In a particularly preferred embodiment, the outer and/or inner layer may include one or more of a polyester, polyacrylate, polyolefin, polyurethane, polyamide and fluoropolymer. More preferably, both layers include a polyester component.

Laminates of the present invention may be manufactured by any method known to those skilled in the art.

In a further preferred embodiment a large cover or tarpaulin may be formed from a series of smaller covers. For example, covers of approximately 1 to approximately 2 metre widths or wider, more preferably approximately 1.4 to approximately 1.7 metre widths may be joined together to provide various sizes and shapes.

The cover of the present invention is suitable for covering a variety of agricultural products, including agricultural products, for example food products. The term ‘food product’ as used herein means an edible substance or a substance for processing into an edible substance, for humans or animals. For example, the food product may be selected from any one or more of a fruit, seed, grain, nut, vegetable, leaf, flower, stem, root, woody plant, part thereof, and processed product thereof. Preferably, food product is a nut, a seed or a grain, more preferably a nut, and most preferably an almond.

The cover of the present invention is also suitable for covering a variety of non-food agricultural products, for example biofuel feedstock, where moisture and spontaneous combustion are particularly important issues.

The cover of the present invention finds particular use in the storage of agricultural products, particularly perishable products such as agricultural food products.

Thus, in a second aspect, the present invention provides a method for storing an agricultural product, including covering the agricultural product with a cover including a polymeric material, wherein the cover is permeable to air, permeable to water vapour and water-resistant.

Preferably, the cover is brought into contact with, or close association with, the agricultural product. The cover may enclose the agricultural product or a part thereof, or simply create a barrier around the agricultural product or a part thereof. In a preferred embodiment, the cover is placed over or around the agricultural product to create a physical barrier to an environment, ambient conditions and/or the elements (i.e. light, wind, rain, snow, etc.). As stated above, the cover need not make a complete containment or surrounding.

The cover may be used to store the agricultural product for any desired period. This may include a period from a day or less, to an entire harvest and postharvest season, or longer. Preferably, the cover may be used to store the agricultural product for a period from approximately 1 day to approximately 1 year, more preferably from approximately 2 weeks to approximately 9 months, more preferably approximately 4 weeks to approximately 3 months. In a particularly preferred embodiment, the period of storage may be as long as approximately 9 months, mostly up to approximately 6 months. In some applications, e.g. biofuel feedstock or animal feed, the duration of storage may be even longer. When used as a liner for holding products in cool storage, products may be stored for approximately 12 months. A food product with a 2 year shelf life, for example, may be stored for longer (preferably not outdoors).

The cover may be used to store, for example, a food product in harvest or post-harvest conditions, outdoor or indoor, and may be used for all or part of the storage period.

In a preferred embodiment, the cover may be made of a laminate as herein described, including a polymeric layer, an inner layer which, in use, contacts the agricultural product, and an outer layer.

A particular benefit of the present invention arises from the permeability and water-resistance properties of the cover. Applicant has surprising found that the cover of the present invention allows the agricultural product to resist condensation build-up and water retention, when compared with a conventional cover, for example one made of polyethylene. This results in a lower moisture content in and around the agricultural product and/or a lower water vapour content in the microenvironment of the agricultural product. This in turn reduces microbial levels and inhibits spoilage of the agricultural product, which also reduces the risk of spontaneous combustion. For example, reduced levels of fungi, such as Aspergillus spp. and Penicillium spp., and bacteria in the agricultural product, such as nuts, stored under the cover, were attained when compared with use of a conventional polymeric cover, for example one made of polyethylene.

Thus, in a third aspect of the present invention there is provided a method for inhibiting spoilage of an agricultural product, including covering the agricultural product with a cover including a polymeric barrier material, wherein the cover is permeable to gases, in particular air, permeable to water vapour and water-resistant.

In an alternate aspect, the present invention provides a method for inhibiting spoilage of an agricultural product, including covering the agricultural product with a cover including a polymeric barrier material, wherein the cover is impermeable to gases, in particular air, permeable to water vapour and water-resistant.

Spoilage of the agricultural product may be inhibited when compared with spoilage of an agricultural product either uncovered or covered by a conventional polymeric cover, for example one made of polyethylene.

Uncovered products are exposed to the elements, and may have even greater risks for microbial growth, spoilage, fire etc. than products covered by a conventional polymeric cover.

By the term ‘spoilage’, as used herein, is meant a loss of product integrity. Spoilage may include one or more of deterioration, decay, tainting, decomposition, breakdown or other degradation of the agricultural product.

In one embodiment, the covered agricultural product or an associated microenvironment is characterised by a condition which inhibits spoilage, wherein said condition is selected form one or more of the following: a moisture content; a water vapour content; a temperature; light and associated heating; a pH; a water activity; a light, and a relative humidity. Preferably, the condition is one or both of moisture content and relative humidity.

In a particularly preferred embodiment, the cover is opaque which provides the added benefits of protection from sunlight and solar heating, which in turn improves temperature differentials. Conventional polymeric covers are substantially clear.

By the term ‘microenvironment’, as used herein, is meant the local environment of the agricultural product or portion thereof covered with the cover of the present invention.

Spoilage may be generated by biochemical processes leading to rancidity and further microbe proliferation, including bacteria and fungi. The microbe may produce mycotoxins including aflatoxins, trichothecenes, fumonisins, zearalenones and patulins. Bacterial species include Escherichia coli, Salmonella spp. and Listeria spp. Fungal species include mould, yeast, Aspergillus spp., Fusarium spp., Penicillium spp, Alternaria spp., Cladisporium spp., Epiccocum spp., and Rhizopus spp.

In a fourth aspect, the present invention provides a method for reducing the risk of spontaneous combustion of an agricultural product, including covering the agricultural product with a cover including a polymeric barrier material, wherein the cover is permeable to gases, in particular air, permeable to water vapour and water-resistant.

In an alternative aspect, the present invention provides a method for reducing the risk of spontaneous combustion of an agricultural product, including covering the agricultural product with a cover including a polymeric barrier material, wherein the cover is impermeable to gases, in particular air, permeable to water vapour and water-resistant.

The risk of spontaneous combustion may be reduced when compared with the risk of spontaneous combustion of an agricultural product either uncovered or covered by a conventional polymeric cover, for example one made of polyethylene.

In one embodiment, the covered agricultural product or an associated microenvironment is characterised by a condition which reduces the risk of spontaneous combustion, wherein said condition is selected form one or more of the following: moisture content; water vapour content; temperature; pH; water activity; light and relative humidity. Preferably, the condition is either one or both of moisture content and relative humidity.

The risk of spontaneous combustion may be characterised by any one or more of a hydrolytic enzyme activation, an oxidative breakdown product content, a volatile gas content, a pyrophoric gas content and a low flash point chemical content.

In a fifth aspect of the present invention, there is provided a method for reducing microbial levels, for example levels of fungi, such as Aspergillus spp. and Penicillium spp., or bacteria in an agricultural product, including covering the agricultural product with a cover including a polymeric barrier material, wherein the cover is permeable to gases, in particular air, permeable to water vapour and water-resistant.

In an alternate embodiment, the present invention provides a method for reducing microbial levels, for example levels of fungi, such as Aspergillus spp. and Penicillium spp., or bacteria in an agricultural product, including covering the agricultural product with a cover including a polymeric barrier material, wherein the cover is impermeable to gases, in particular air, permeable to water vapour and water-resistant.

Microbial levels may be reduced when compared with microbial levels in an agricultural product either uncovered or covered by a conventional polymeric cover, for example one made of polyethylene.

Fungal levels may be significantly lower in the agricultural product stored under the cover of the invention, when compared with agricultural product stored under a conventional cover. The levels may vary depending on the season, the initial level of contamination and/or the initial moisture content of the agricultural product. For example, fungal levels may be at least approximately 2 times lower, more preferably at least approximately 10 times lower, more preferably at least approximately 20 times lower, more preferably at least approximately 30 times lower in agricultural products such as nuts after storage under the cover. The agricultural product may be stored for a period of approximately 1 week to approximately 1 year, more preferably approximately 2 weeks to approximately 9 months, more preferably approximately 4 weeks to approximately 3 months.

Fungal levels may be between 0 and approximately 2000 cfu/g, more preferably between 0 and approximately 1000 cfu/g, more preferably between 0 and approximately 500 cfu/g in agricultural products such as nuts after storage under the cover for a period of approximately 1 week to approximately 1 year, more preferably approximately 2 weeks to approximately 9 months, more preferably approximately 4 weeks to approximately 3 months.

The reduced fungal levels may in turn result in reduced levels of mycotoxins in an agricultural product, such as nuts, stored under the cover, when compared with use of a conventional polymeric cover, for example one made of polyethylene.

Bacterial levels may be significantly lower in the agricultural product stored under the cover of the invention, when compared with agricultural product stored under a conventional cover. The levels may vary depending on the season, the initial level of contamination and/or the initial moisture content of the agricultural product. For example, bacterial levels may be at least approximately 2 times lower, more preferably at least approximately 10 times lower, more preferably at least approximately 50 times lower, more preferably at least approximately 100 times lower in agricultural products such as nuts after storage under the cover for a period of approximately 1 week to approximately 1 year, more preferably approximately 2 weeks to approximately 9 months, more preferably approximately 4 weeks to approximately 3 months, when compared with use of a conventional polymeric cover, for example one made of polyethylene.

Bacterial levels may be between 0 and approximately 50,000 cfu/g, more preferably between 0 and approximately 20,000 cfu/g, more preferably between 0 and approximately 10,000 cfu/g in agricultural products such as nuts after storage under the cover for a period of approximately 1 week to approximately 1 year, more preferably approximately 2 weeks to approximately 9 months, more preferably approximately 4 weeks to approximately 3 months.

In one embodiment, the stored agricultural product or an associated microenvironment is characterised by a condition which inhibits spoilage and/or reduces the risk of spontaneous combustion, wherein said condition is selected form one or more of the following: moisture content; water vapour content; temperature; pH; water activity; light and associated heating, and relative humidity. Preferably, the condition is either one or both of moisture content and relative humidity.

The agricultural product may be stored as herein described, for any period as herein described. This may include a period from a day or less, to an entire harvest and postharvest season, or longer. Preferably, the cover may be used to store the agricultural product for a period from approximately 1 day to approximately 1 year, more preferably from approximately 2 weeks to approximately 9 months, more preferably approximately 4 weeks to approximately 3 months. In a particularly preferred embodiment, the period of storage may be as long as approximately 9 months, mostly up to approximately 6 months. In some applications, e.g. biofuel feedstock or animal feed, the duration of storage may be even longer. When used as a liner for holding products in cool storage, products may be stored for approximately 12 months. A food product for human consumption with a 2 year shelf life, for example, may be stored for longer (preferably not outdoors).

Preferably, the covered agricultural product or part thereof or an associated microenvironment or part thereof is characterised by either or both of a moisture content and a relative humidity significantly lower than those attained using a conventional polymeric cover, for example one made of polyethylene.

More preferably, the covered agricultural product or part thereof or an associated microenvironment or part thereof is characterised by either or both of a moisture content of between 0 and approximately 30%, between 0 and approximately 20%, more preferably between 0 and approximately 10%, more preferably between 0 and approximately 8%; and a relative humidity of between approximately 30% and approximately 80%, more preferably between approximately 45% and approximately 70%, more preferably between approximately 50% and 65%.

These levels are particularly applicable to storage of nuts with respect to product integrity. For example, for almond kernels, the preferred moisture content for long term storage is approximately 6%. For minimising the risk of spontaneous combustion in products such as hay, a moisture content of less than approximately 15% is preferred.

Both moisture content and relative humidity may be higher if the product has a higher starting moisture content.

The present invention finds particular use in agriculture. For example, typical harvesting processes of certain agricultural products, for example food products, involve storage of the agricultural product in the field in stockpiles. Applicants have surprisingly found that the cover of the present invention provides superior microclimate storage conditions resulting in reduced microbial growth, less spoilage and/or decreased risk of spontaneous combustion.

The present invention will now be more fully described with reference to the accompanying examples and drawings. It should be understood, however, that the description following is illustrative only and should not be taken in any way as a restriction on the generality of the invention described above.

### BRIEF DESCRIPTION OF THE DRAWINGS/FIGURES

FIG. 1 shows the effect of the protective cover, BWT, in contrast to ST, on microclimatic conditions such as relative humidity in the top layers of a nut stockpile.

FIG. 2 shows the effect of the protective covers, BWT and ST, on reducing diurnal fluctuations in relative humidity in the top layers of a nut stockpiles.

FIG. 3 shows the effect of the protective cover, BWT and ST on reducing diurnal fluctuations in temperature in the middle layers of a nut stockpiles.

FIG. 4 shows the effect of the protective covers, BWT and ST, on the moisture content of a product, e.g. nut kernels and the remaining hulls and shells (H&S).

FIG. 5 shows the difference in the growth of microbial spp. e.g. Aspergillus spp. in a product before (baseline) and after storage under the protective covers, BWT and ST.

FIG. 6 shows the difference in the growth of microbial spp. e.g. Penicillium spp. in a product before (baseline) and after storage under the protective covers, BWT and ST.

FIG. 7 shows the difference in the growth of microbial spp. e.g. Fusarium spp. in a product before (baseline) and after storage under the protective covers, BWT and ST.

FIG. 8 shows the difference in the growth of bacteria in a product before (baseline) and after storage under the protective covers, BWT and ST.

FIG. 9 shows the difference in the percentage of mouldy kernels before (baseline) and after storage under the protective covers, BWT and ST.

### DETAILED DESCRIPTION OF THE EMBODIMENTS

A protective cover (BWT) made of breathable, waterproof material and a conventional polymeric cover (ST) made of polyethylene were comparatively evaluated. The BWT consisted of a three-layer laminate; a 100% polyester woven exterior, a bi-component ePTFE middle layer, and a 100% polyester knitted backing. The BWT has a hydrostatic resistance of greater than 100 (Australian Standard (AS) 2001.2.17), water repellency scale of 100 (AS 2001.2.16), and breathability of less than 13 m²Pa/W (ISO 11092). A wide-span BWT was fabricated by joining 1.4 metre width pieces of the textile laminate together. In this application, a 14 metre wide BWT was used. The seams were heat sealed so they were water proof. Tapes were attached along the perimeter of the BWT, to aid handling and fastening of the wide-span cover.

Two stockpiles each consisting of approximately 30 tonnes of soft-shelled almonds were provided. Each stockpile measured approximately 8 metres long, 8 metres wide and 4.5 metres high. As each stockpile was built, smart sensors that monitor temperature and relative humidity were implanted at three depths within each stockpile. Nut samples were collected from corresponding sensor positions for determination of baseline moisture and microbial levels. One stockpile was covered with a BWT and the other a ST for nine weeks. At the end of the storage period, the covers were removed and the stockpiles comparatively evaluated.

### Example 1

This example illustrates the effect of the BWT on microclimatic conditions in a stockpile.

A modular network of smart sensors was connected to a microcontroller (μSmart Logger) equipped with a solar panel, battery and modem for remote data downloading. Three smart sensors were implanted in approximately the same three positions of each stockpile to monitor continuously the microclimatic conditions, at 10 centimetres depth from the top of the stockpile (top), at 2 metres depth (mid) and at 3 metres (base) depths.

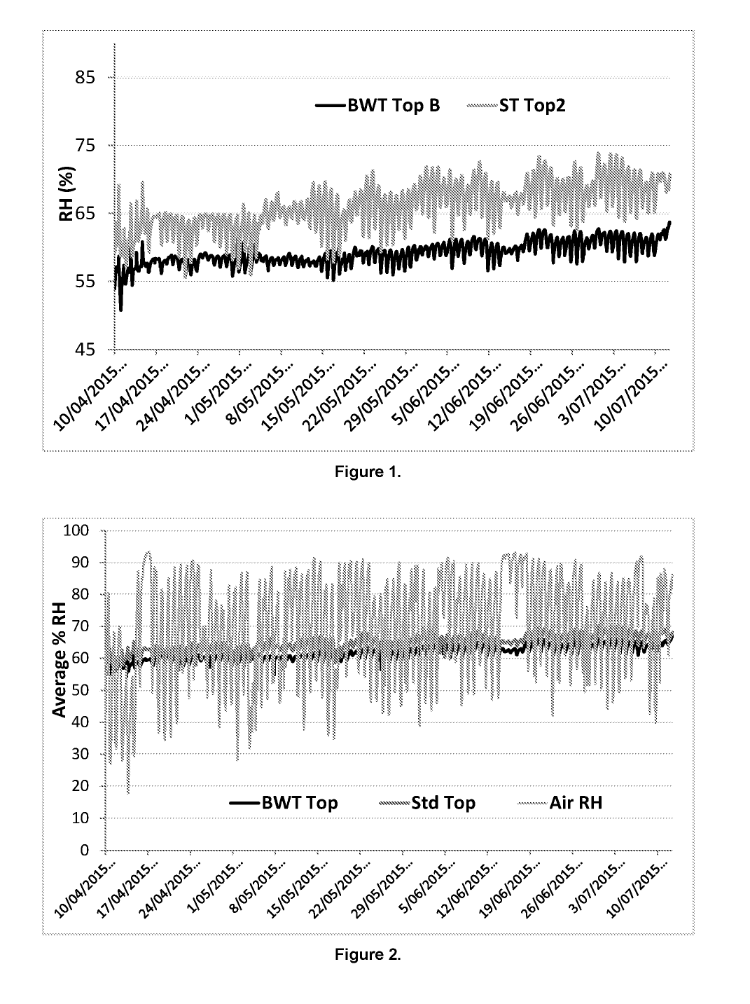

Microclimatic data was collected during the storage period. Microclimatic profiles show that the top layers of nuts in one of the positions on the ridge of the stockpile under the BWT had lower relative humidity than those covered with the ST (FIG. 1). The BWT had enabled greater evaporation of moisture than the ST. Nuts in the surface and mid layers under the ST were exposed to higher temperatures and relative humidity than those under the BWT.

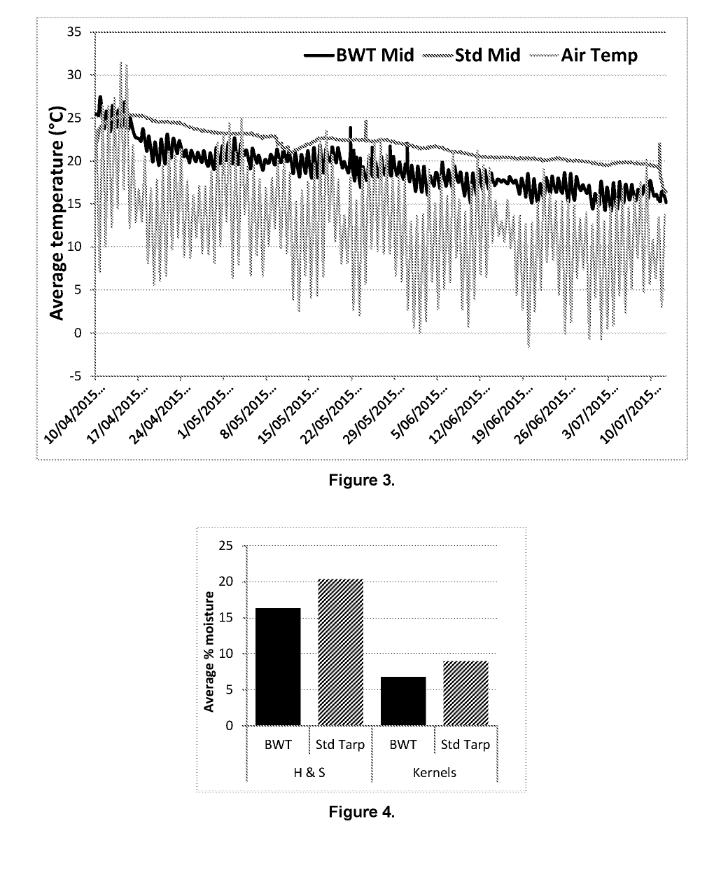

In the absence of a cover, the surface and mid layers of the stockpile would have been exposed to large and also diurnal fluctuations in environmental conditions (FIGS. 2 and 3). The corresponding exposure to the rain or high relative humidity of 70-90% for 10-18 hours on a daily basis is undesirable for storage of a product.

### Example 2

This example illustrates the effect of the BWT on maintaining low moisture content in a product.

Nuts were collected from approximately the same position of each stockpile at three different depths; at 0-20 centimetres from the top (top), at 2 metres (mid) and at 3 metres (base), at nine weeks after storage. Kernels were extracted and the moisture content of kernels and remaining hulls and shells (referred to as hulls/shells) were determined using the protocols outlined in ISO 665-2000.

Kernels and hulls/shells in the top layers of the stockpile under the BWT had lower moisture contents than those covered by ST (FIG. 4). Moisture content in both kernels and hulls/shells under the ST far exceeded the acceptable thresholds of 6% and 13%, respectively.

### Example 3

This example illustrates the effect of the BWT on limiting fungal growth on a product.

Nuts were sampled from the stockpiles at setting up of the trial and after storage under the BWT and ST covers for nine weeks. They were collected from approximately the same three positions of each stockpile along the ridge on the top of the stockpiles, with three replicates for each position. A 20 gram sub-sample was ground in sterile peptone water. The suspension was serially diluted and plated onto a mycological culture medium. Fungal colony types and numbers were assessed after incubation at 25° C.

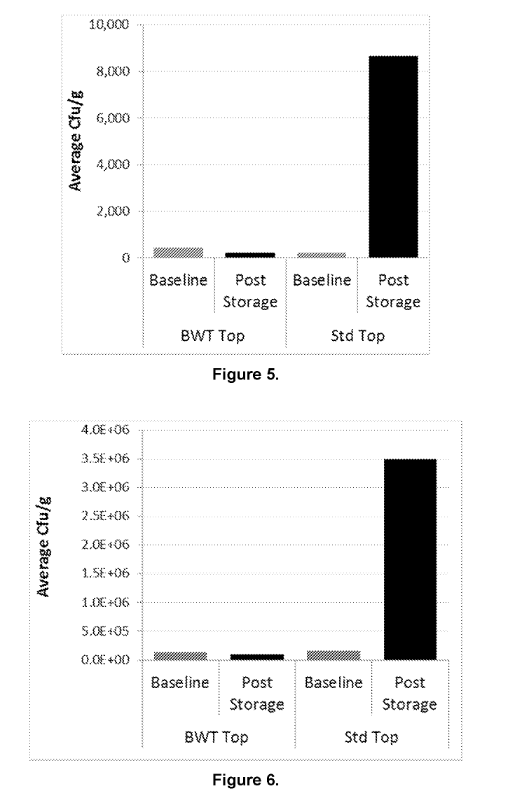

An illustration of the difference in the level of mycotoxic fungi, e.g. Aspergillus spp., on the product protected by BWT, is shown in FIG. 5. Aspergillus numbers were 40 times lower in nuts protected by BWT than those protected by ST.

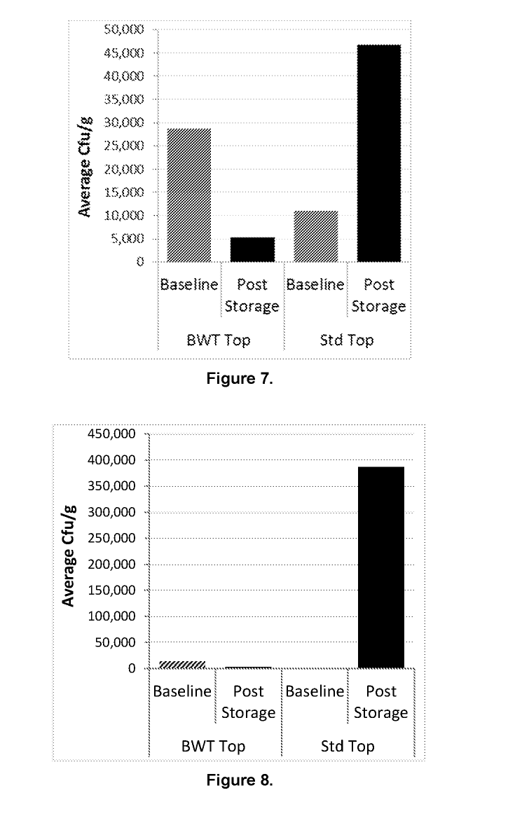

An example of the effect of BWT on limiting spoilage and plant pathogenic fungi, e.g. Penicillium and Fusarium spp., are illustrated in FIGS. 6 and 7. Penicillium and Fusarium numbers were 36 and 8.7 times lower, respectively, in nuts protected by BWT than those protected by ST.

The three examples also show that through maintaining dryness in the covered nuts, BWT was effective in limiting microbial growth, as there was no increase in microbial numbers above the baseline levels. However, with the ST cover which tended to promote build-up of relative humidity, both Aspergillus, Fusarium and Penicillium levels had increased markedly above the baseline levels.

### Example 4

This example illustrates the effect of the BWT on limiting bacterial growth on a product.

Nuts before and after nine weeks storage under the BWT and ST covers were collected and processed as described in Example 3. A 20 gram subsample was ground in sterile peptone water, and an aliquot spread on a bacteriological agar medium and then incubated at 35° C. Bacterial colonies were counted within 48 hours after incubation.

After nine weeks storage, the bacterial counts in nuts covered with BWT was 143 times lower than those covered by ST (FIG. 8). The data also show bacterial growth increased over time on nuts covered by the ST, whereas those under the BWT did not increase. The build-up in relative humidity and condensation under the ST was a contributing factor for the marked difference in bacterial numbers. The data also provide evidence that controlling moisture in a product is an effective measure in limiting microbial growth.

### Example 5

This example illustrates the effect of a BWT on product quality.

Nuts were collected from the top, middle and basal sections of approximately the same positions of each stockpile covered with a BWT and a ST. A sub-sample of 300 nuts was assessed visually for a range of quality criteria, these included: fungal growth and rots (Penicillium, Aspergillus, Rhizopus, Fusarium spp.), and general deterioration in quality.

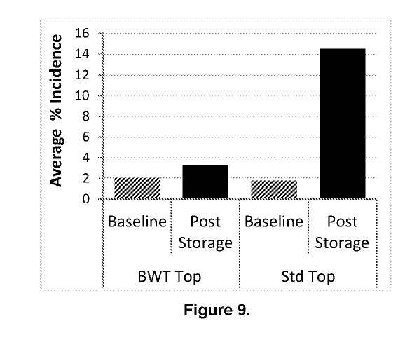

Nuts in the top layers of the stockpile covered by the ST were more exposed to condensation and environmental fluctuations. As a result, the nuts were poorer in quality and had a higher incidence of mould infection than those protected by the BWT (FIG. 9). The higher levels of moisture in the nuts also caused the kernels to deteriorate, which resulted in rancidity and off-flavours.

### Example 6

This example illustrates the indirect effect of a BWT on minimising mycotoxin levels in a product.

Nuts were collected from approximately the same positions at the top, middle and basal sections of the stockpiles covered with a BWT and ST after storage in the field for nine weeks. Kernels were extracted from the nut samples and 80 grams of kernels were ground in a blender. A 5 gram homogenised sub-sample was extracted with 20 millilitres of acetonitrile/water (84/16) by shaking for 30 minutes. 10 millilitres of the supernatant was passed through a Mycosep cartridge (Romer labs). The eluant was collected and evaporated to dryness using rotary evaporator (40° C.). The residue was reconstituted with 1 millilitre of mobile phase (20% acetonitrile with 0.2% formic acid) and was injected (20 microlitres) in a liquid chromatography-mass spectrometer (LC-MS) for analysis.

Matrix matched calibration curves were used to determine aflatoxin levels in the nut samples. A mixed solution of aflatoxins (B1, B2, G1, G2, and acetonitrile) (Sigma-Aldrich) was used to prepare dilutions for the matrix matched calibration curves. A standard curve of the four aflatoxins was prepared by spiking ‘blank’ almond (5 grams) with 0.22 to 18 parts per billion (ppb) aflatoxins.

LC-MS/MS analysis was conducted on a triple quadrupole mass spectrometer (6460A, Agilent Technologies, USA), equipped with a quaternary solvent delivery system, a column oven, a photo-diode array detector and an auto-sampler. An aliquot (20 microlitres) of each sample was injected and separated on a Hydro Synergi C18 analytical column (150 millimetres×2.0 millimetres, 5 micrometre particle size, Phenomenex, NSW, Australia) at 30° C. The following solvents with a flow rate of 200 microlitres/minute were used: A—0.2% formic acid solution in purified water; and B—0.2% formic acid solution in acetonitrile. The elution profile was a linear gradient for B of 20% to 100% over 18 minutes in solvent A. Ions were generated using an electrospray source in the positive mode under conditions set following optimisation using a solution of aflatoxins. MS experiments in the full scan (parent and product-specific) and the selected reaction monitoring (SRM) mode were conducted.

Nut samples under the ST cover were more exposed to condensation; had a higher moisture content and Aspergillus levels, and correspondingly higher levels of aflatoxins than those under the BWT.

It is to be understood that various alterations, modifications and/or additions may be made without departing from the spirit of the present invention as outlined herein.

As used herein, except where the context requires otherwise, the term “comprise” and variations of the term, such as “comprising”, “comprises” and “comprised”, are not intended to be in any way limiting or to exclude further additives, components, integers or steps.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and/or regarded as relevant by a person skilled in the art.

1. A cover for an agricultural product, said cover comprising a polymeric barrier material, wherein the cover is permeable or impermeable to gases, permeable to water vapour and water-resistant.

2. The cover according to claim 1, wherein the cover is characterised by one or more of the following: a water-vapour resistance (breathability) of between 0 and approximately 13 m²Pa/W according to ISO 11092; a hydrostatic resistance of between approximately 100 and approximately 275 kPa according to AS 2001.2.17; and a water repellency scale of approximately 100 according to AS 2001.2.16.

3. The cover according claim 1, wherein the polymeric barrier material includes one or more of a fluoropolymer, polyolefin, polyester, polyurethane, polyethylene, polyvinyl chloride and polyvinylidene chloride.

4. (canceled)

5. The cover according to claim 3, wherein the polymeric barrier material includes polytetrafluoroethylene.

6. The cover according to claim 1, wherein the cover comprises a laminate including the polymeric barrier material.

7. The cover according to claim 6, wherein the laminate comprises an outer layer, a layer formed from the polymeric barrier material and an inner layer, which, in use, is in contact with the agricultural product.

8. (canceled)

9. (canceled)

10. (canceled)

11. (canceled)

12. The cover according to claim 1, wherein the agricultural product is selected from any one or more of a fruit, seed, grain, nut, vegetable, flower, leaf, stem, root, woody plant, part thereof, and processed product thereof.

13. (canceled)

14. The cover according to claim 12, wherein the agricultural product is an almond.

15. The cover according to claim 1, wherein the cover is permeable to air.

16. (canceled)

17. A method for storing an agricultural product, comprising covering the agricultural product with a cover according to claim 1.

18. (canceled)

19. (canceled)

20. The method according to claim 17, wherein the cover is placed in contact with at least a portion of the agricultural product.

21. A method selected from the group consisting of:
i. inhibiting spoilage of an agricultural product;
ii. reducing the risk of spontaneous combustion of an agricultural product; or
iii. reducing microbial levels in an agricultural product,
said method comprising covering the agricultural product with a cover including a polymeric barrier material, wherein the cover is permeable or impermeable to gases, permeable to water vapour and water-resistant.

22. The method according to claim 21, wherein the covered agricultural product or an associated microenvironment is characterised by a condition which inhibits spoilage, reduces the risk of spontaneous combustion or inhibits microbial growth, wherein said condition is selected form one or more of the following: light and associated heating, moisture content; water vapour content; temperature; pH; water activity; and relative humidity.

23. The method according claim 21, wherein the spoilage is selected from one or more of rancidity and microbe proliferation.

24. (canceled)

25. The method according to claim 23, wherein the microbe is mycotoxin-producing and wherein the mycotoxins are selected from any one or more of but not limited to aflatoxins, trichothecenes, fumonisins, zearalenones and patulins.

26. (canceled)

27. A method according to claim 23, wherein the microbe is a bacterium selected from one or more of foodborne pathogens including but not limited to Escherichia coli, Salmonella spp. and Listeria spp.

28. The method according to claim 23, wherein the microbe is a fungus selected from one or more of a mould or yeast, including but not limited to Aspergillus spp., Fusarium spp., Penicillium spp, Alternaria spp., Cladisporium spp., Epiccocum spp., and Rhizopus spp.

29. (canceled)

30. (canceled)

31. (canceled)

32. The method according to claim 21, wherein the risk of spontaneous combustion is characterised by any one or more of a hydrolytic enzyme activation, an oxidative breakdown product content, a volatile gas content, a pyrophoric gas content and a low flash point chemical content.

33. (canceled)

34. (canceled)

35. (canceled)
